(19) United States
(12) Patent Application Publication
(10) Pub. No.: US 2003/0019942 A1
(43) Pub. Date: Jan. 30, 2003

(54) System and method for electronically readable card having power source

(76) Inventor: George W. Blossom, West Chester, PA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/201,198

(22) Filed: Jul. 24, 2002

Related U.S. Application Data
(60) Provisional application No. 60/307,180, filed on Jul. 24, 2001.

(51) Int. Cl. G06K 19/06

(52) U.S. Cl. 235/492

(57) ABSTRACT

An improved transaction card contains electronic components and a thin, flexible, power assembly such as a rechargeable metal-lithium battery which may be used whether or not the card is coupled to a reader. The power assembly may include a built-in power source such as a thin film solar cell for charging the power storage device from that source, on-card. The invention also relates to a method for selectively powering the plastic card from the various power sources.

### FIELD OF THE INVENTION

The invention generally relates to electronically readable cards, such as credit cards or other account, transaction, identification or other cards that contain memory, processor or other electronic components. More particularly, the invention relates to a card having electronic components and an integral power supply to power those components.

### BACKGROUND OF THE INVENTION

Electronically readable cards, such as identification and financial and other transaction cards, are widely used for payments, deposits, cash withdrawals and other transactions, as well as for security and other purposes. Such instruments can be generally classified into magnetic cards and smart cards. Magnetic cards, for example credit cards, employ a magnetic strip or tape for storing data that identify the card owner, the account number, PIN number or other security code and other information, in a passive fashion on the magnetic tracks.

Smart cards on the other hand may contain an electronic processor and a memory device for processing information on the card itself. A conventional smart card generally includes a processor coupled to an electrically erasable programmable read-only memory (EEPROM), read-only memory (ROM) and/or random access memory (RAM). These components may be fabricated on a single integrated chip. The processor may execute instructions stored on ROM and temporarily store data in RAM, whereas the non-volatile EEPROM may be used for storing data uniquely identifying a given smart card, or other information. Smart cards also generally include an input/output (I/O) interface for exchanging I/O signals between the smart card and an external system, such as a reader. The I/O interface may take the form of a set of electrical contacts to connect to a reader communicating with a backend database or other processing hardware. The I/O interface may likewise take the form of a wireless radio frequency (RF), infrared (IR) or other interface for wirelessly coupling the card and the external system.

The external system coupling to the card may be, for example, a card reader, a merchant's point of sale system, a security authorization device, an automated teller machine or other hardware. Smart cards are used to store personal information in Europe, the United States and elsewhere including personal, medical and financial information and other data.

The significant amount of information stored on a smart card is not, however, generally accessible or capable of being manipulated without being coupled to the card reader because the card is not powered unless it is registered with that external system.

Incorporation of batteries onto a smart card would provide the required operating potential to the smart card. However, conventional batteries, such as alkaline, lithium ion or NiMH rechargeables, have disadvantages for use on a smart card. Such batteries would increase the thickness and weight of the smart card. This decrease in flexibility may increase the chance of chipping, snapping, leakage or other damage when the card is manufactured, swiped or read, stored in a billfold or otherwise handled.

Overall, smart cards and other transaction instruments generally remain more bulky and less flexible than counterpart magnetic credit, banking and other cards.

### SUMMARY OF THE INVENTION

The invention overcoming these and other problems in the art relates to a system and method for an electronically readable card having a power source, which in one regard provides an independent power supply to operate the electronic parts of the card, even when the card is not powered from an external system. The invention in another regard relates to a card having an integral power source that is sufficiently flexible and thin to maintain an overall size and flexibility consistent with bank, credit and other transaction cards.

The power storage device may include a rechargeable battery, a capacitor, or other rechargeable power storage device that can be charged from an external system or from an internal power generator, such as a solar cell or piezoelectric element. The card may incorporate a power selection module for selectively powering the electronic components from the power storage device, the internal power generator, or an external power system.

In another regard, the invention relates to a method for selectively regulating the electronic components of a card, in one embodiment of which an output voltage from the power storage device may be measured, and a power source selected depending on consumption rates and available power outputs from internal and external sources.

### BRIEF DESCRIPTION OF THE DRAWINGS

The present invention can be understood more completely by reading the following Detailed Description of the Preferred Embodiments, in conjunction with the accompanying drawings.

FIG. 1 is a block diagram of an internal structure of a smart card, according to an embodiment of the invention.

FIG. 2 is a flowchart illustrating a method for powering a plastic card according to an embodiment of the invention.

FIG. 3 is a flow chart illustrating embodiment of a method for powering a plastic card according to an embodiment of the invention.

### DETAILED DESCRIPTION OF THE PREFERRED EMBODIMENTS

The invention relates to an electronically readable card, generally having a plastic or other body having a thin, comparatively flexible construction and an integral power assembly that provides an effective power supply to the electronics built into or attached to the card. The power assembly may include a rechargeable power storage device that can be charged from an external system, or from a built-in power generator.

The built-in power generator may be a portable power source that can provide sufficient power to fully charge the power storage device within a relatively brief period, such as 12 hours or less. In one embodiment, the built-in power generator may be or include a renewable power source such as a solar cell, a piezoelectric element, a fuel cell or other generation element. The power assembly may include a power selection module for selectively powering the card with power from the power storage device, the power generator or the external supply depending on power consumption rates and available power outputs from the internal and external sources.

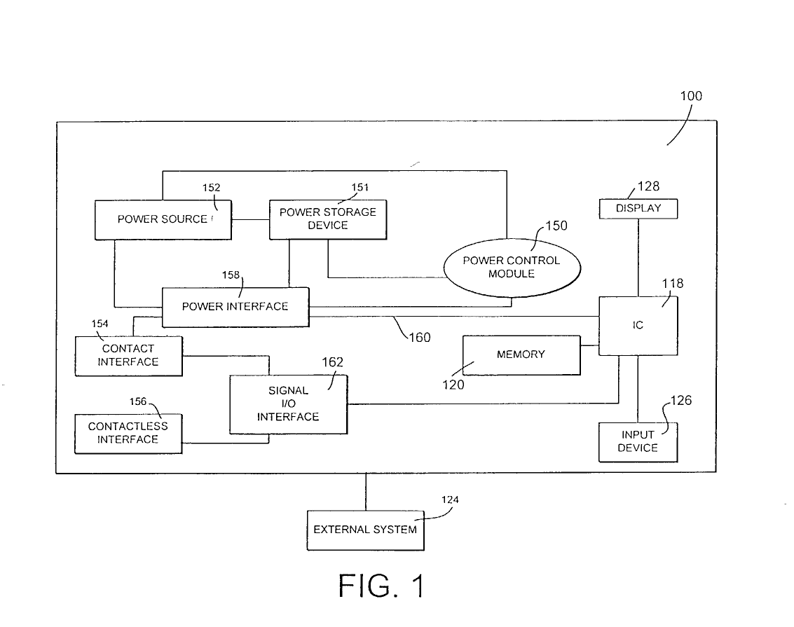

FIG. 1 is a block diagram illustrating components of an electronically readable card 100, according to an embodiment of the invention. The card 100 may be or include, for instance, an identification card, a medical card, a membership card, a biometrically-enabled card, a smart card or other transaction or other instrument. The card 100 may includes an input device 126 such as a keypad, and a display 128. The display 128 may be any conventional display, such as a light emitting polymer (LEP) display, that is sufficiently thin and flexible to maintain the overall size and flexibility of the card 100. Examples of known LEPs are disclosed in copending U.S. patent application Ser. No. 09/693,893 entitled “Plastic Card with LEP Display”, which application is commonly owned with this application and which is incorporated herein by reference.

Both input device 126 and display 128 may be coupled to a processor 118, such as a microprocessor or microcontroller. The processor 118 may communicate with memory 120. A user of card 100 may access data stored within the memory 120 or within the external system 124 via the input device 126 and either a contact interface 154, or a contact-less interface 156. While both a contact interface 154 and a contact-less interface 156 are illustrated, it will be understood than in embodiments only one of contact interface 154 and contact-less interface 156 may be included.

The card 100 may also include contact interface 154 or contact-less interface 156 and signal I/O interface 162 for independently or selectively providing communication between the card 100 and the external system 124. If coupled by electrical contact, the signals may be communicated off the card 100 via contact interface 154. If coupled without physical contact, the signals may be communicated wirelessly, such as by BlueTooth or 802.11 radio signals, capacitive or inductive coupling, by optical signals such as infrared signals, or other wireless signals being transmitted or received by card 100 via contact-less interface 156. Information received from external system 124 can also be displayed in the display 128.

Data such as account balance, user name, date and time, account status and other information may be displayed on the display 128. For example, the user may enter input data to the card 100 via the input device 126, and data returned from the card 100 may be viewed on the display 128.

The card 100 also includes a rechargeable storage device 151 and a power source 152 for charging the power storage device 151. The power storage device 151 may be or include a battery, such as a polymer batter or other type. Besides charging the power storage device 151, in implementations the power source 152 may also provide power directly to the electronics and to the display 128 within the card 100.

Preferably, the power source 152 and the storage device 151 may be sufficiently thin and flexible as to maintain the overall flexibility and size of the smart card, compared for instance to conventional credit cards or smart cards.

The card 100 may further include a power control module 150 operatively connected to the power storage device 151, the power source 152, and the power interface 158 for selecting the power storage device 151, the power source 152 or an external power source for powering the card 100. For example, power control module 150 may include a voltage sensor (not shown) for measuring the output voltage for the power source 152 or the power storage device 151, and hardware or software for comparing the output voltage with a minimum effective voltage for operating the electronic components of the card 100.

The power control module 150 may further include a power switch or other means for selecting power from the power storage device 151 or other power source. The power control module 152 may power the card with power from the power storage only, if the output voltage from the power storage device 151 is greater or equal to the minimum effective voltage. If the output voltage from the power storage device 151 is less than the effective voltage required, the power control module 152 may generate a message on the display 128 indicating that the power storage device 151 requires recharging.

The power interface 158 may provide power to the integrated circuit 118, input device 126 and display 128 via power line 160 by selectively providing power from power source 152, the power storage device 151 or from the external system 124 via contact interface 154 or contact-less interface 156 depending on available power from any one or more of those power sources, the available voltage, current and drain time remaining on those resources, or other criteria. In embodiments, more than one source may be combined in series or parallel to achieve desired voltage, current or other characteristics. The card 100 may further include mechanisms to conserve power such as a kickstart circuit, a sleep mode circuit or other power management techniques.

The card 100 in embodiments may also include multi-media features powered by the power storage device 151, or the power source 152. For example, the power storage device 151 or the power source 152 may power a speaker, a microphone, a video camera device, a biometric device or cause the display element to produce a series of images (e.g. a video clip) on the display 128. Also, the power storage device 151 or other power source may power communication elements of a contact-less version of card 100.

The power source 152 in one embodiment may consist of a thin, flexible photovoltaic solar cell. Employing a solar cell as a power source 152 allows recharging of the power storage device 151 without access to an external power source. In one embodiment, power source 152 may take the form of thin film solar cells. Examples of thin film solar cells that can be used are described in U.S. Pat. No. 5,853,498 to Beneking et al. and U.S. Pat. No. 6,124,545 to Bauer et al., which are incorporated herein by reference. The power source 152 may be sufficiently flexible and thin to preserve the overall flexibility and size of the card 100, compared to conventional credit cards or smart cards. More than one solar cell may be coupled in parallel or series configuration to obtain sufficient power levels, if needed.

When implemented as a rechargeable source, the power storage device 151 may be or include any conventional rechargeable power storage device. The power storage device 151 may be sufficiently thin and flexible to maintain the overall size and flexibility of the card. Examples of rechargeable platforms that can be used include metal-sulfur battery cells such as the ones described in U.S. Pat. Nos. 4,833,048, 4,917,974 to DeJonghe et al., and U.S. Pat. Nos. 5,162,175 to Visco et al., which are incorporated herein by reference. Thin film cell lithium-sulfur batteries are also suitable. Examples of thin-film cell lithium-sulfuric batteries are described in U.S. Pat. No. 6,030,720 to Chu et al., which is incorporated herein by reference. Multiple cells may be stacked together in series or parallel configuration to form a battery delivering an effective power supply to power the card, if needed.

The card 100 may include any transaction or other instrument that has at least one electronic component that requires electrical power. For example the invention may be used to build and manage credit cards, debit cards, transfer funds cards, smart cards, identity cards (e.g. drivers' license) and security cards. The card 100 can be made of any material or compound material that is flexible and comparatively light, such as plastic or other polymer materials commonly used with magnetic cards commonly associated with MASTERCARD®, VISA®, AMERICAN EXPRESS®, and ATM banking cards.

The size parameters or dimensions of the card may vary to accommodate the various electronic and electrical component of the card. The length and width parameters of the card may be similar to the length and width of conventional magnetic type or smart cards, such as but not limited to a thickness of about 0.035 inches or less. The length and width of the card may also vary, for instance from about 0.5 inch to about 4 inches. Other dimensions are possible.

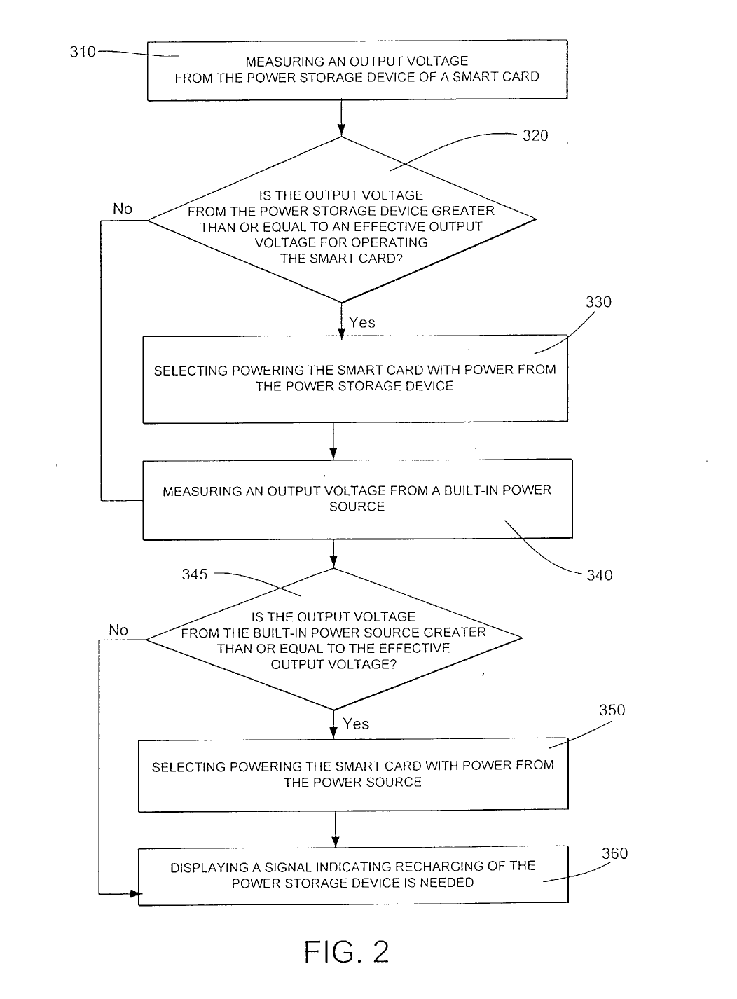

According to an embodiment of the invention illustrated in FIG. 2, another method for powering a card 100 is illustrated. The method includes a step of measuring an output voltage from the power storage device according to block 310, and a step of comparing the output voltage from the power storage device with an effective output voltage according to block 320. If the output voltage from the power storage device is greater than or equal to the effective output voltage according to the yes branch of block 320, a step of selecting powering the smart card with power from the power storage device according to block 330 is performed. If the output voltage from the power storage device is less than the effective output voltage, according to the “no” branch of block 320, then a step of measuring output voltage from the built-in power source is performed. A step of determining whether the output voltage from the power source is greater than or equal to the effective output voltage is then performed according to block 345. If the output voltage from the power source is greater than or equal to the effective output voltage, according to the “yes” branch of block 345, the smart card is powered with power from the power source, according to block 350.

If the output voltage from the power source is not greater than or equal to the effective output voltage, according to the “no” branch of block 345 a signal is displayed indicating that recharging of the power storage device may be needed, according to block 360.

In another embodiment the card 100 may be powered only from the power storage device 152, and the power source 151 may be used only for recharging the power storage device 151.

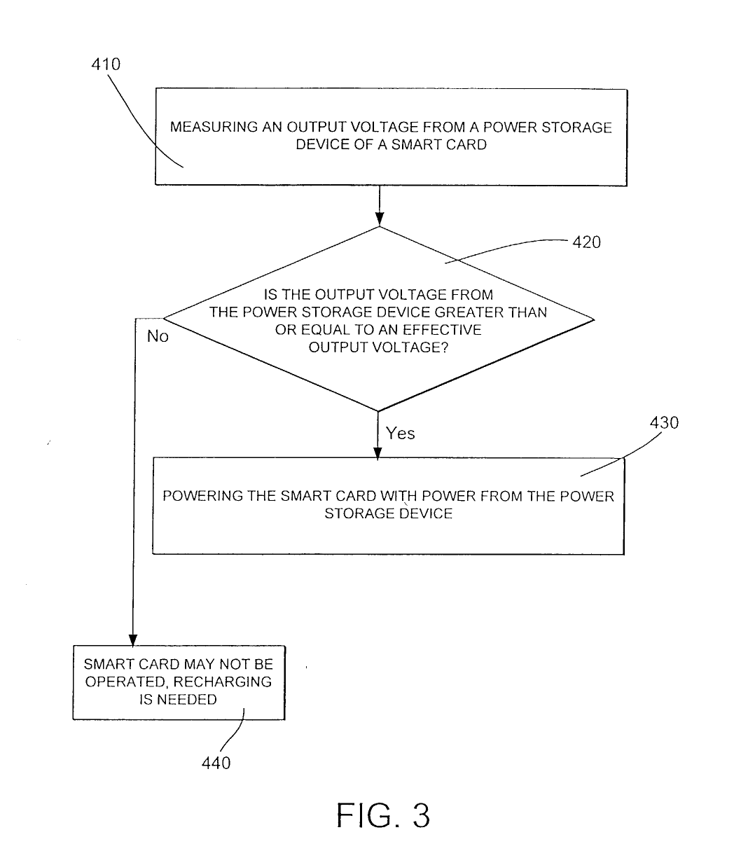

A method according to another embodiment of the invention is illustrated in FIG. 3. The method includes steps of measuring an output voltage from a power storage device of a smart card, according to block 410, and performing a test to determine whether the output voltage from the power storage device is greater than or equal to an effective output voltage for operating the smart card, according to block 420. If the output from the power storage device is greater than or equal to the effective output voltage, according to the “yes” branch of block 420, powering the smart card with power from the power storage device, according to block 430.

If the output voltage from the power storage device is not greater than the effective output voltage, according to the “no” branch of block 420, then the card may display a signal indicating that the card may not be operated and recharging is needed, according to block 440.

While the foregoing description includes many details and specificities, it is to be understood that these have been included for purposes of explanation only, and are not to be interpreted as limitations of the present invention. Many modifications to the embodiments described above can be made without departing from the spirit and scope of the invention. The scope of the invention is intended to be limited only by the following claims.

What is claimed is:

1. A card, comprising:
at least one electronic component; and
a rechargeable power storage device for powering the at least one electronic component, the rechargeable power source being sufficiently thin to maintain flexibility of the card.

2. The card of claim 1, wherein the card further comprises a power source connected with the power storage device for charging the power storage device

3. The card of claim 2, further comprising means for selectively powering the electronic component with power from at least one of the power storage device and the power source.

4. The card of claim 1, wherein the card has a thickness of less than about 0.3 inches.

5. The card of claim 1, wherein the rechargeable power storage device comprises at least one of a thin film metal-sulfur battery and a thin film lithium battery.

6. The card of claim 2, wherein the power source comprises at least one of a thin film solar cell and a piezoelectric element for powering the card and for charging the power storage device.

7. The card of claim 1, further comprising an integrated circuit.

8. The card of claim 7, further comprising an input device operatively connected to the integrated circuit for entering data.

9. The card of claim 1, further comprising a display.

10. A smart card for transferring information between the smart card and an external system, the smart card having the capability of being accessed by a user, the smart card comprising:
at least one integrated circuit for controlling at least one function of the card;
an external interface connected to the integrated circuit, the external interface for coupling to an external system;
a rechargeable power storage device;
a power source connected with the power storage device for charging the power storage device;
a power control module, the power control module selectively powering the smart card with power from at least one of the power storage device or the power source.

11. The smart card of claim 10, wherein the power control module selects at least one of the storage device and the power source for powering the smart card when the card is not powered from the external system.

12. The smart card of claim 10, wherein the power control module comprises:
means for measuring an output voltage from the power source and the power storage device;
means for comparing the output voltage from the power storage and the power source with a minimum effective voltage required for operation of the card; and
means for selecting power from the power storage device if the output voltage from the power storage device is greater than or equal to the minimum effective voltage or from the power source if the output voltage from the power storage device is less than the minimum effective voltage and the output from the power source is greater than or equal to the minimum effective voltage.

13. The smart card of claim 10, wherein the power source comprises at least one of a thin film solar cell and a piezoelectric element.

14. The smart card of claim 10, wherein the power storage device comprises at least one of a thin film metal-sulfur battery and a thin film lithium battery.

15. The smart card of claim 10, further comprising electronic memory.

16. A method for powering a card, comprising steps of:
a) detecting the available power from a power storage device and a power source; and
b) selectively powering the card with power from at least one of the power storage device and the power source, depending on the available power detected in the step a) of detecting.

17. The method of claim 16, further comprising steps of:
c) measuring an output voltage from the power storage device;
d) comparing the output voltage from the power storage device to an effective output voltage;
e) powering the card with power from the power storage device if the output voltage from the power storage device is greater than or equal to the effective output voltage;
f) measuring an output voltage from the power source if the output voltage from the power storage device is less than the effective output voltage; and
g) powering the card with power from the power source if the output voltage from the power source is greater than or equal to the effective output voltage.

18. The method of claim 17, further comprising a step of h) displaying a signal indicating that the card may not be operated and that recharging of the power storage device is needed if the output voltage from the power source is less than the effective output voltage.

19. The method of claim 16, wherein the power source comprises at least one of a thin film solar cell and a piezoelectric element.

20. The method of claim 16, wherein the power storage device comprises at least one of a thin film metal-sulfur battery and a thin film lithium-sulfur battery.
